(19) United States
(12) Patent Application Publication
(10) Pub. No.: US 2012/0158500 A1
(43) Pub. Date: Jun. 21, 2012

(54) METHOD AND SYSTEM FOR MATCHING SELLERS WITH BUYERS

(75) Inventors: Thomas G. Hochstatter, Austin, TX (US); Christopher W. McKinzie, Lakeway, TX (US); John Leonard, Austin, TX (US)

(73) Assignee: American Express Travel Related Services Company, Inc., New York, NY (US)

(21) Appl. No.: 12/968,493

(22) Filed: Dec. 15, 2010

(51) Int. Cl. G06Q 30/00

(52) U.S. Cl. 705/14.53

(57) ABSTRACT

Methods, systems and computer readable medium are provided for matching providers with potential buyers. According to one method, custom proposed merchant offerings are established from merchant offerings data, stored in a database, based at least in part on at least one of a profile and transaction history of a first entity. The custom proposed merchant offerings are organized into a subset of proposed merchant offerings based, at least in part, on the transaction history of the first entity. The method further includes organizing the subset of proposed merchant offerings further based, at least in part, on geographic location to create an organized subset of proposed merchant offerings. The organized subset of proposed merchant offerings is presented to the first entity through a user interface.

### FIELD

The present disclosure generally relates to online marketing. More particularly, the disclosure relates to matching sellers with potential buyers to provide customized on-line marketing solutions to the sellers and the buyers.

### BACKGROUND

Online items offered by various merchants may be listed in their respective websites. Typically, a buyer may visit a merchant's website and browse through information, including features and pricing information, on various items offered by the merchant. The buyer may also visit websites of other merchants offering similar items. The buyer may then compare the pricing and other features of the items offered. The buyer can subsequently choose a merchant that suits him the best and make a purchase. However, effectiveness of such technique depends upon the buyer's knowledge about different merchants offering similar items of the buyer's interest, and consequently, the buyer may not always make an optimal choice of a suitable merchant. Further, it may be time consuming for the buyer to visit web-sites of each and every merchant.

Online portals where participating merchants upload information concerning their items are available and a buyer may sign in to such a portal to access this information. Thus, such portals form an interface between the buyers and the merchants by providing a platform bringing together a plurality of buyers and a plurality of merchants. While these portals are able to recommend items to the buyers, the recommended items may not always be the most relevant to the buyers as these portals fail to take the buyers' transaction history into account.

On the other hand, the merchants typically run targeted marketing campaigns to market their items to prospective buyers. The merchants often contact third party service providers to identify the prospective buyers and distribute marketing material to the prospective buyers. Running a targeted marketing campaign in this manner may be very expensive, especially for small merchants. Further, the prospective buyers are generally identified using some demographic criteria and transaction behavior of the buyers is ignored. Consequently, such marketing campaigns may not be very effective.

Given the foregoing, what is needed is a system, a method and a computer readable medium for matching merchants with potential buyers and/or buyers with merchants to provide customized on-line marketing solutions to the merchants and the buyers.

### SUMMARY OF THE INVENTION

The present disclosure meets the above-identified need by providing methods, systems and non-transitory computer-readable medium for matching sellers with potential buyers to provide customized on-line marketing solutions to the sellers and the buyers.

According to one embodiment, a system, method, or article of manufacture for matching providers (e.g., merchants) with potential buyers is disclosed. The merchants offer items (e.g., merchant offerings) to buyers. An exemplary method includes establishing custom proposed merchant offerings from merchant offerings data stored in a database. The custom proposed merchant offerings are established based at least in part on at least one of a profile and transaction history of a first entity (such as, a buyer). The custom proposed merchant offerings are organized into a subset of proposed merchant offerings based, at least in part, on the transaction history of the first entity. The method further includes organizing the subset of proposed merchant offerings further to create an organized subset of proposed merchant offerings. This is carried out based, at least in part, on geographic location of at least one of the first entity, the merchant and the merchant offerings. Finally, the organized subset of proposed merchant offerings is presented to the first entity through a user interface.

Further features and advantages of the present disclosure as well as the structure and operation of various embodiments are described in detail below with reference to the accompanying drawings.

### BRIEF DESCRIPTION OF THE DRAWINGS

A more complete understanding of the disclosure may be derived by referring to the detailed description and claims when considered in connection with the Figures, wherein like reference numbers refer to similar elements throughout the Figures, and:

FIG. 1 is an overview of an exemplary system in which a transaction account holder matching system may be deployed, in accordance with various embodiments;

FIG. 2 is an exemplary block diagram of the account holder matching system, in accordance with various embodiments;

FIG. 3 is a flowchart illustrating an exemplary method of implementing the account holder matching system, in accordance with various embodiments;

FIG. 4 is a flowchart illustrating an exemplary method of profiling a merchant, in accordance with various embodiments; and

FIG. 5 is a flowchart illustrating an exemplary method of profiling a buyer, in accordance with various embodiments.

### DETAILED DESCRIPTION OF EXEMPLARY EMBODIMENTS

The detailed description of exemplary embodiments described herein makes reference to the accompanying drawings, which show the exemplary embodiment by way of illustration and its best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present disclosure is directed to systems, methods and computer readable medium for matching providers with sales contacts. A computer-based system performs the matching of the provider (i.e. the merchant 108) with the buyers 102 in a seamless manner. The matching may be implemented based on one or more parameters including transaction history of a buyer 102, geographic location of the buyer 102 or the merchant 108 or the merchant offerings or any combination thereof, profiles of the buyer 102 and/or profiles of the merchant 108. Additionally, the matching may be implemented using parameters such as real-time transaction data and/or real-time transaction analysis results of the buyer 102, the merchant 108 or the merchant offerings or any combination thereof. In another embodiment, the matching may be implemented using parameters such as buyer 102 and merchant 108 interaction based on time and/or weather. The matching may be implemented using parameters such as the intentions of the buyer 102 and merchant 108 related to transactions, such as business, pleasure and/or the like. Various embodiments include providing custom proposed merchant offerings to the buyers 102 in a convenient manner. Further, various embodiments also provide the merchant 108 customized marketing solutions enabling the merchant 108 to reach out to the potential buyers 102 in an organized manner, without having to invest substantially (or with minimal investment in) into advertising and other marketing techniques.

A “buyer” 102 is any entity that buys products and/or services (hereinafter collectively referred to as, “merchant offerings”) offered by a merchant 108. In an embodiment, the buyer 102 may be an individual, a group of individuals, a corporate firm, government organization, software, hardware and/or the like. The terms “buyer”, “customer”, “entity” have been used interchangeably in this disclosure.

A “merchant” 108 generically refers to any provider offering products and/or services to a buyer 102. In one embodiment, the merchant 108 may be an individual, a group of individuals, a corporate firm, government organization, software, hardware and/or the like. Further, the terms “seller”, “provider”, “vendor”, “merchant” have been used interchangeably in this disclosure.

In various embodiments, the buyer 102 and the merchant 108 may be transaction account holders (i.e. cardmembers). “Account holders”, or similar phrases as used herein, may include any individual, group, charity, entity, software and/or hardware that is associated with an account in certain ways, such as a user, customer, member, rights holder, benefit from the account, affiliated with the account and/or the like. Transaction account holders may include all (or any subset of) account holders associated with a particular issuer, account holders with a certain type of account, primary account holders, subsidiary account holders, relatives of account holders, responsible parties of account holders, parties impacted by the account and/or the like.

Transaction accounts may include transaction instruments such as credit cards, debit cards, pre-paid cards, charge cards, gift cards and the like. The transaction instruments may be issued by a transaction account issuer, for example, American Express.

The terms “items”, “merchant offerings”, “products”, “services” and the like have been used interchangeably in this disclosure and may refer to any kind of item, service or product offered by a merchant 108. Moreover, “item” may include any good, service, information, experience, event, show, access, restriction, monetary value, loyalty points, non-monetary value and/or the like.

In different embodiments, the buyer 102 may also be offering items. Similarly, the merchant 108 may also be buyers 102 of some items. Thus, the terms “buyer” 102 and “merchant” 108 are context specific and represent a consumer of items and a provider of items, respectively, for a particular context. In a different context, their respective roles may switch. For example, a seller in one situation may be a buyer in another situation and vice versa.

The present disclosure is now described in terms of an exemplary system, hereinafter referred to as an account holder matching system. In one embodiment, the account holder matching system 106 may be deployed by any entities such as a transaction account issuer, financial institution, merchant 108, and/or third party service providers. The nomenclature used herein is for convenience only and is not intended to limit the application of the present disclosure. It will be apparent to one skilled in the relevant art how to implement the present disclosure in alternative embodiments.

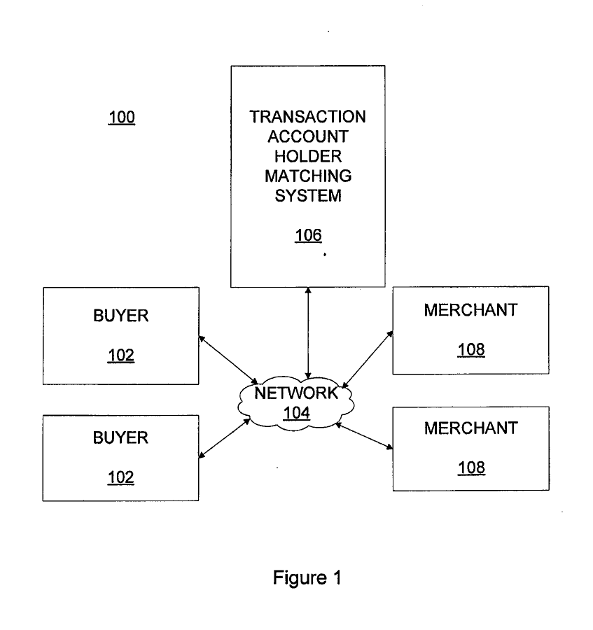

With reference to FIG. 1, in an embodiment, a system 100 includes an account holder matching system 106. The system 100 further includes a buyer 102, a network 104, and a merchant 108.

The account holder matching system 106 provides the buyer 102 proposed merchant offerings of the merchant 108. Further, the account holder matching system 106 may also allow the buyer 102 to select the proposed merchant offerings and enable the buyer 102 to contact a merchant 108 of the selected proposed merchant offerings to complete a transaction. In additional embodiments, the account holder matching system 106 recommends a merchant 108 to the buyer 102. According to an embodiment, the account holder matching system 106 may also recommend a buyer 102 to the merchant 108 and allow the merchant 108 to contact the recommended buyer 108 directly.

According to various embodiments, the account holder matching system 106 achieves the aforementioned objectives by matching the buyer 102 with the merchant 108 or vice versa. The account holder matching system 106 performs the matching based, at least in part, upon at least one of the profile of the buyer 102, profile of the merchant 108, transaction history of the buyer 102. The account holder matching system 106 obtains historical transaction data of the buyer 102 and/or the merchant 108 and maintains the historical transaction data in a database, in accordance with one embodiment. In an embodiment, a transaction is performed by an associated transaction instrument and may be carried out either online or offline at a point of sale of a merchant 108.

Further, the account holder matching system 106 maintains data regarding merchant offerings by the merchant 108. The merchant offerings data may be obtained in a variety of ways described below. The account holder matching system 106 may use the merchant offerings data to present the custom proposed merchant offerings to the buyer 102.

According to one embodiment, the account holder matching system 106 may be implemented as Software as a Service (SaaS). A person skilled in the art will recognize various other techniques known in the art to deploy the account holder matching system 106. In various embodiments, the buyer 102 and the merchant 108 may register with the account holder matching system 106. Furthermore, the buyer 102 and the merchant 108 may log in to the account holder matching system 106 by supplying suitable access credentials, for example, a username and a password.

The buyer 102 and/or the merchant 108 may communicate (in any manner discussed herein) with the account holder matching system 106 via any network using any of known communication device, such as a computer, a mobile phone, a Personal Digital Assistant (PDA), a laptop, a pocket PC and/or the like. The communication device may comprise any hardware and/or software suitably configured to facilitate input, receipt and/or review of information discussed herein.

The different elements shown in system 100 may communicate with each other over the network 104. As used herein, the term “network” shall include any electronic communications means which incorporates both hardware and software components of such. Communication among the parties in accordance with the present disclosure may be accomplished through any suitable communication channels, such as, for example, a telephone network, an extranet, an intranet, Internet, point of interaction device (point of sale device, personal digital assistant, cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the disclosure is frequently described herein as being implemented with TCP/IP communications protocols, the disclosure may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards And Protocols (1998); Java 2 Complete, various authors, (Sybex 1999); Deborah Ray And Eric Ray, Mastering Html 4.0 (1997); and Loshin, TCP/IP Clearly Explained (1997) and David Gourley and Brian Totty, HTTP, The Definitive Guide (2002), the contents of which are hereby incorporated by reference.

Alternately, the buyer 102 and/or the merchant 108 may communicate with the elements shown in system 100 over a web client (not shown). The web client comprises any hardware and/or software suitably configured to facilitate input, receipt and/or review of information discussed herein. The web client includes any device (e.g., personal computer), which communicates (in any manner discussed herein) with the account holder matching system 106 via any network discussed herein. Such browser applications comprise Internet browsing software installed within a computing unit or system to conduct online transactions and communications. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that the web client may or may not be in direct contact with the account holder matching system 106. For example, the web client may access the services of the account holder matching system 106 through another server.

As those skilled in the art will appreciate, the web client includes an operating system (e.g., Windows NT, 95/98/2000, OS2, UNIX, Linux, Solaris, MacOS, etc.) as well as various conventional support software and drivers typically associated with computers. The web client may include any suitable personal computer, network computer, workstation, minicomputer, mainframe or the like. The web client can be in a home or business environment with access to a network. In an exemplary embodiment, access is through a network or the Internet through a commercially available web-browser software package. The web client may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network.

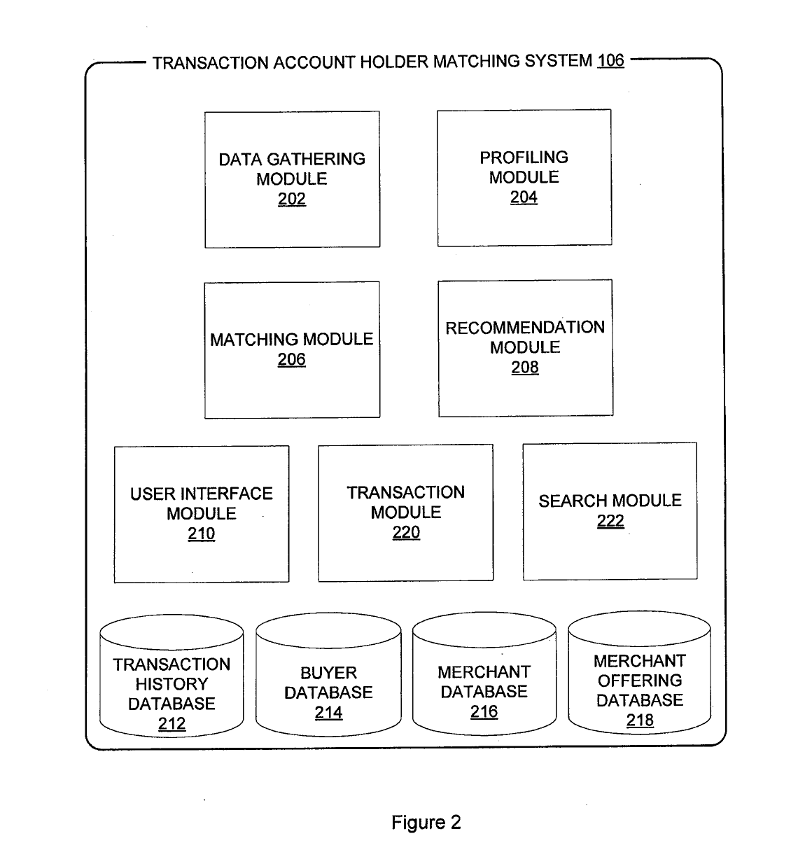

With reference to FIG. 2, the account holder matching system 106 includes a data gathering module 202, a profiling module 204, a matching module 206, a recommendation module 208, and a user interface module 210. The account holder matching system 106 further includes a transaction history database 212, a buyer database 214, a merchant database 216, and a merchant offering database 218. The account holder matching system 106 may further include a transaction module 220 and a search module 222.

The data gathering module 202 obtains data associated with transactions between the buyer 102 and the merchant 108. Transaction data may include real time data such as the name of the buyer 102, the name of the merchant 108, the type of purchased product and/or service, a location of purchase, a date of purchase, time of purchase, external factors associated with the purchase (e.g. weather conditions, economic conditions, season, seasonal factors, climate, etc), the quantity of purchases, the amount spent, intentions for purchase (e.g. business, or pleasure), a description of the merchant 108, a mode of payment, and/or transaction instrument details. The data gathering module 202 may then store the transaction data in the transaction history database 212.

According to one embodiment, the data gathering module 202 further obtains merchant offering data associated with the merchant 108. The merchant offering data for a merchant 108 may include at least one of goods, such as products, services provided by the merchant 108, pricing information, geographic location associated with the items, information about the products and/or services, discounts offered, experience(s) associated with the items, a description associated with the products and/or services and the like. The merchant offering data may be obtained in a variety of ways as will be described herein. The data gathering module 202 may then store the merchant offering data in the merchant offering database 218.

Once the data gathering module 202 receives the transaction data related to a transaction, the profiling module 204 may dynamically (e.g., substantially in real-time) update appropriate profiles of the buyer 102 and the merchant 108 associated with the transaction. In various embodiments, the profiling module 204 analyzes the transaction data of the current transaction and historical transaction data of the buyer 102 to create taxonomy classes and assigns appropriate taxonomy classes to the buyer 102, thereby automatically updating the profile of the buyer 102. Further, according to one embodiment, the profiling module 204 may also check whether items present in the transaction and corresponding merchant 108 are already stored in respective databases. If the items are not present, merchant offering data for that merchant 108 is updated in the merchant offering database 218. Further, the profile of the merchant 108 is also suitably updated. Further, if the merchant 108 is not present, a new merchant is registered with the account holder matching system 106 and the profiling module 204 creates the new merchant profile. In an embodiment, to create a profile for the new merchant, the profiling module 204 triggers the data gathering module 202 to obtain merchant offering data for the new merchant. Thereafter, the profiling module 204 analyzes the merchant offering data to create taxonomy classes and categorizes the items into the taxonomy classes, thereby creating the profile for the new merchant.

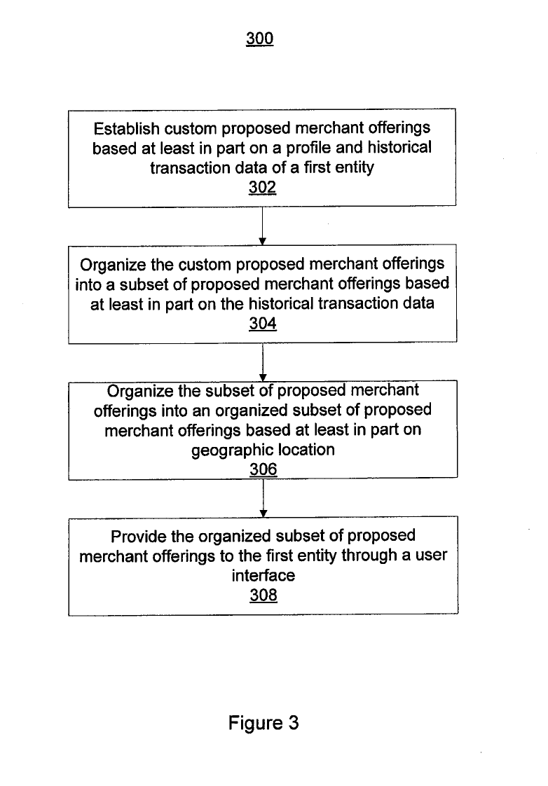

In an embodiment, the recommendation module 208 establishes custom proposed merchant offerings for the buyer 102 based at least in part upon the profile of the buyer 102 and historical transaction data of the buyer 102. The recommendation module 208 may also use other parameters, such as, profiles of other buyers, profiles of the merchant 108, historical transaction data of the other buyers and/o the like to establish the custom proposed merchant offerings. The recommendation module 208 retrieves the merchant offering data from the merchant offering database 218. In one embodiment, the recommendation module 208 may also establish the custom proposed merchant offerings based at least in part upon merchant offerings from a merchant 108 suitable for the buyer 102. In this case, the recommendation module 208 may invoke the matching module 206 to identify the merchant 108. The matching module 206 then matches the profile of the buyer 102 with the profiles of the plurality of other buyers, for example, by comparing the taxonomy classes of items assigned to the buyer 102 and/or the merchant 108. Various embodiments of establishing the custom proposed merchant offerings are described in conjunction with FIG. 3.

The recommendation module 208 may further organize the custom proposed merchant offering in a subset of proposed merchant offerings based at least in part upon the historical transaction data of the buyer 102 at any suitable time. In addition, the recommendation module 208 may further organize the subset of proposed merchant offerings in an organized subset of proposed merchant offerings based at least in part on geographic location. The recommendation module 208 may use the geographic location of the buyer 102, the geographic location of merchants 108 corresponding to the subset of proposed merchant offerings, the geographic location of the proposed merchant offerings or any combination thereof.

In one embodiment, the recommendation module 208 may also organize the organized subset of proposed merchant offerings based at least in part upon selections made by a second buyer from respective proposed merchant offerings. The second buyers may be representative of buyers having purchasing behavior similar to the buyer 102. In one embodiment, the recommendation module 208 may invoke the matching module 206 to identify the second buyer. The matching module 206 may then analyze either the profiles of the other buyers, the historical transaction data of the other buyers or both, and identify the second buyers having the closest match with the profile and the historical transaction data, respectively, of the buyer 102.

The recommendation module 208 may forward the organized subset of proposed merchant offerings to the user interface module 210. The user interface module 210 presents the organized subset of proposed merchant offerings to the buyer 102. The organized subset of proposed merchant offerings may be presented in a rank order. In one embodiment, the user interface module 210 presents the organized subset of proposed merchant offerings on a dashboard of the buyer's 102 electronic communication device. The buyer 102 can access her dashboard by logging in to her account.

The user interface module 210 further enables the buyer 102 to make a distinct selection of a merchant offering from the organized subset of proposed merchant offerings. The user interface module 210 may prompt the buyer 102 whether the buyer 102 wants to purchase the selected merchant offering. Upon confirmation by the buyer 102, the user interface module 210 forwards the distinct selection of the merchant offering to the transaction module 220. The transaction module 220 provides contact information of merchant(s) corresponding to the selected merchant offering to the buyer 102 and the buyer 102 may initiate a transaction with the merchant(s) directly. In another embodiment, the transaction module 220 may provide a merchant form to the buyer 102, either by presenting the merchant form through the user interface module 210, or by sending the merchant form via an e-mail and the like. The buyer 102 then enters information, such as, buyer contact details, purchase volume for the selected merchant offerings, billing details etc. and sends the merchant form to the account holder matching system 106 which then facilitates the transaction using the merchant form, in accordance with one embodiment.

The user interface module 210 may also allow the buyer 102 to save the selection for future use. In an embodiment, the selection may be stored in the buyer database 214 and may be used or processed for transaction at a later time. These stored selections may be used for establishing custom proposed merchant offerings for the buyer 102 or other buyers, updating the profile of the buyer 102.

The user interface module 210 may provide the buyer 102 an option to search for items on the user interface. The search may be conducted using a keyword, items type, merchant name or any combination thereof. According to one embodiment, keywords may be suggested to the buyer 102 based upon at least one of the profile and the historical transaction data. In an additional embodiment, a semantic search may also be performed. The search module 222 then searches through the merchant offering database 218 to retrieve merchant offerings relevant to the search. The user interface module 210 may give the buyer 102, an option to save search results for future reference, for example, to buy a merchant offering in the search results at a later time.

Additionally, the user interface module 210 may also provide the user with an option of reviewing her transaction history, for example, in the form of a transaction statement. The transaction statement may include a record of a purchase and sale associated with the buyer 102 and include information such as transaction date, merchant name, merchant address, transaction amount, product purchased and the like. The transaction statement may be customized as per requirements of the buyer; for example, the transaction statement may be organized merchant-wise, purchase-wise, by merchant type, product type, or may be queried by specific date range etc.

In various embodiments, the user interface module 210 also enables the buyer 102 and the merchant 108 to specify respective buying and selling preferences. These preferences may be stored in the buyer database 214 and the merchant database 216, respectively. Further, the user interface module 210 may give to the buyer 102 and the merchant 108, an option of altering personal information. The personal information for a buyer 102 may include information such as, name, address, age, gender, annual income, marital status, family information, billing details and the like. The personal information for a merchant may include details such as, name, address, size of company, annual revenue, annual profit, contact details of point of sales etc. The buyer database 214 may store the personal information of the buyer 102. Similarly, the merchant database 216 stores the personal information of the merchant 108.

The system 100 and/or the account holder matching system 106 (or any of the other components described herein) may further include a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and/or database. Various databases used herein may include: the transaction history database 212, the buyer database 214, the merchant database 216, the merchant offering database 218, and/or like databases useful in the operation of the system 100 and/or the account holder matching system 106. As will be appreciated by one of ordinary skill in the art, one or more of the components of the system 100 and/or the account holder matching system 106 may be embodied as a customization of an existing system, an add-on product, upgraded software, a stand alone system (e.g., kiosk), a distributed system, a method, a data processing system, a device for data processing, and/or a computer program product. Accordingly, individual system 100 and/or account holder matching system 106 components may take the form of an entirely software embodiment, an entirely hardware embodiment, or an embodiment combining aspects of both software and hardware. Furthermore, individual system 100 and/or account holder matching system 106 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

One skilled in the art will appreciate that account holder matching system 106 may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the disclosure, any suitable data storage technique may be utilized to store data without a standard format. Data sets may be stored using any suitable technique, including, for example, storing individual files using an ISO/DEC 7816-4 file structure; implementing a domain whereby a dedicated file is selected that exposes an elementary file containing one a data set; using data sets stored in individual files using a hierarchical filing system; data sets stored as records in a single file (including compression, SQL accessible, hashed via a key, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the account holder matching system 106, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, encrypting, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken.

One skilled in the art will also appreciate that, for security reasons, any databases, systems, devices, servers or other components of the account holder matching system 106 may consist of any combination thereof at a single location or at multiple locations, wherein each database or system includes any of various suitable security features, such as firewalls, access codes, encryption, decryption, compression, decompression, and/or the like.

With reference to FIG. 3, a buyer 102 accesses the account holder matching system 106 by supplying appropriate credentials, for example, a username and a password. The buyer 102 may then generate a proposed merchant offering request to obtain proposed merchant offerings suitable for the buyer 102. In one embodiment, the proposed merchant offering request may be implicit and may be generated when the buyer 102 logs into the account holder matching system 106 automatically. In an alternate embodiment, the buyer 102 generates the proposed merchant offering request explicitly, for example, by clicking on an appropriate button on the user interface.

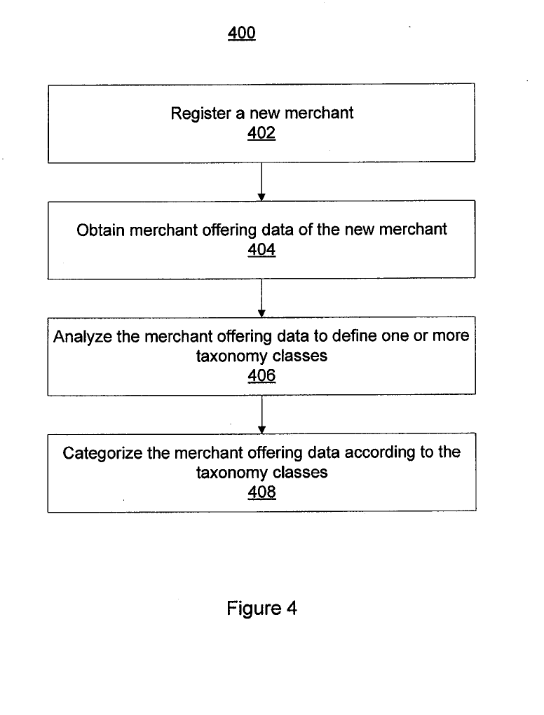

The account holder matching system 106 then establishes custom proposed merchant offerings from merchant offering data (step 302). The merchant offering data for a merchant may include a good such as a product, service provided by the merchant 108, pricing information, geographic location associated with the item, information about the product and/or service, discount offered, experience(s) associated with the item, a description associated with the product and/or service and the like. The merchant offering data may be stored in the merchant offering database 218. The merchant offering database 218 may be populated with the merchant offering data through a variety of ways as described later in conjunction with FIG. 4.

The custom proposed merchant offerings are established based, at least in part, upon at least one of a profile of the buyer 102 (a first entity) and historical transaction data of the first entity. In an embodiment, the custom proposed merchant offerings are established based on the transaction history of the buyer 102. For example, if the historical transaction data of the buyer 102 reveals a recent purchase of personal computers, merchant offerings related to one or more computer accessories such as headphones, mouse pads, speaker systems, computer tables and the like may be included in the custom proposed merchant offerings. These products may be offered by the same merchant or by different merchants. Further, if the historical transaction data of the buyer 102 reveals a preferred merchant, the custom proposed merchant offerings are established to include merchant offerings from the identified preferred merchants. Similarly, other observable trends in the historical transaction data of the buyer 102 may be utilized in establishing the custom proposed merchant offerings.

In another embodiment, the custom proposed merchant offerings may also be established based on the profile of the buyer 102. For example, if the profile of the buyer 102 indicates that the buyer 102 falls in a taxonomy class of consumer electronic goods, the custom proposed merchant offerings may be established to include a merchant offering related to consumer electronic goods. Further, the profile of the buyer 102 may be matched with profiles of the merchant 108 by matching the taxonomy classes assigned to the buyer 102 and the merchant 108 to identify suitable merchants for the buyer 102, in accordance with one embodiment. For example, if the buyer 102 is bulk purchaser of ladies cosmetics (as indicated by an associated taxonomy class in the buyer's 102 profile), merchant offerings from wholesale merchants of ladies cosmetics are included in the custom proposed merchant offerings and retail merchants of such products may be ignored, wherein the wholesale and retail merchants in the ladies cosmetics taxonomy class may be identified from corresponding merchant profiles.

Further, in various embodiments, a combination of the historical transaction data and the profile of the buyer 102 may be used for establishing the custom proposed merchant offerings. Also, according to additional embodiments, various other parameters such as, but not limited to, the demographic information of the buyer 102 (for example, age, gender, marital status, family information, net annual income, personal interests etc.), the buyer's 102 preferences, geographic location and the like may also be used while establishing the custom proposed merchant offerings.

The account holder matching system 106 organizes the custom proposed merchant offerings into a subset of proposed merchant offerings based at least in part on the historical transaction data of the buyer 102 (step 304). In an embodiment, the historical transaction data may be used to prioritize and/or filter the custom proposed merchant offerings into the subset of proposed merchant offerings. In one example, the custom proposed merchant offerings may include laptops offered by two different merchants in separate price ranges and that the historical transaction data suggests that the buyer 102 only purchases laptops in a certain price range. In this case, the account holder matching system 106 may only include the merchant 108 that sells the laptops falling in the buyer's 102 price range in the subset of proposed merchant offerings. Other patterns extracted from the historical transaction data such as, frequency of purchase from a merchant, cycle of purchase for a class of products, volume of purchase and/or the like, may similarly be used to organize the custom proposed merchant offerings into the subset of proposed merchant offerings.

The account holder matching system 106 further organizes the subset of proposed merchant offerings into an organized subset of proposed merchant offerings based at least in part on geographic location (step 306). The account holder matching system 106 may use the geographic location of the buyer, or the geographic location of the merchant 108 or the geographic location of the merchant offering or any combination thereof to create the organized subset of the proposed merchant offerings.

For example, merchant offerings from merchants located closed to the geographic location of the buyer 102 may be ranked higher than other merchants offering similar merchant offerings. According to another example, if the buyer 102 prefers to buy a particular class of goods from a particular location, the organized subset of proposed merchant offerings may organize proposed merchants in an increasing order of distance from the particular location.

Further, in additional embodiments, the organized subset of proposed merchant offerings may be further organized based at least in part on historical merchant offering selections by a second entity, for example, a second buyer. According to one embodiment, the second entity may be identified by matching the profile of a first buyer with profiles of other buyers and selecting a buyer having the most similar to the first buyer's profile as the second entity. In an alternate embodiment, the second entity may be suitably identified by matching the historical transaction data of the first buyer with that of other buyers and selecting the buyer 102 with most matching transaction data as the second buyer. The account holder matching system 106 may employ any of known statistical/non-statistical techniques to perform the matching, according to one embodiment. Matching criteria may be used for the matching, for example, purchase interests, the demographic information, geographic location, bulk of purchase, the time lapsed between successive transactions, total amount spent and the like. Thus, the second entity represents an entity having similar purchase behavior and/or interests as the first entity. Though the organization of the organized subset of proposed merchant offerings is described herein based upon a single second entity data, it need not be so and a person skilled in the art will appreciate that the organized subset of proposed merchant offering may be organized using data from more than one second entities.

The account holder matching system 106 provides the organized subset of proposed merchant offerings to the buyer 102 through a user interface (step 308). The organized subset of proposed merchant offerings may be presented in a ranked order, with a more relevant merchant offering getting a higher rank, in accordance with one embodiment. In alternate embodiments, the list may be sorted with respect to any one of the geographic location, demographic information of the merchant 108, taxonomy classes of the proposed merchant offerings and the like.

Further, the buyer 102 may select a distinct merchant offering from the organized subset of proposed merchant offerings presented by the user interface. The account holder matching system 106 receives the selection of the distinct merchant offering and may save the selection, for example, in the buyer database 214 and/or the merchant database 216 for future reference.

The merchant(s) 108 providing the selected merchant offering may then be contacted and the contact information of the buyer 102 may be provided. The merchant(s) 108 may then directly contact the buyer 102. In an alternate embodiment, a transaction request may be generated upon selection of the merchant offering by the buyer 102. The transaction request may then be forwarded to corresponding merchant(s). In one embodiment, the transaction request includes the contact information of the buyer 102. Alternately, the buyer 102 may also be provided with the contact information of the corresponding merchant(s), for example, leading the buyer 102 to a website of the corresponding merchant(s) and the buyer 102 may initiate the transaction directly with the merchant(s) 108. In additional embodiments, a merchant introduction form is presented to the buyer 102. The merchant introduction form may seek various details such as, contact information, shipping address, selected merchant offering(s), quantity, billing details etc.

Further, if a transaction between the transaction account holder and the merchant 108 occurs, the transaction is recorded and stored in the transaction history database 212. The profile of the buyer 102 and/or the corresponding merchant(s) may be appropriately modified using the transaction data.

With reference to FIG. 4, the account holder matching system 106 registers a new merchant (step 402). The new merchant may be registered upon receiving a request from the new merchant. In other embodiments, the account holder matching system 106 may register the new merchant when a merchant not registered with the account holder matching system 106 is encountered in transactions. In another embodiment, any of the plurality of buyers may inform the account holder matching system 106 about the new merchant. Upon registration, the new merchant may be provided with a username and a password to access various functionalities of the account holder matching system 106. Further, the account holder matching system 106 may prompt the merchant 108 to enter information, such as, contact details, a URL address, revenue, net annual income, number of employees, geographic locations of point of sales, buying/selling preferences and the like.

Once the new merchant is added, the account holder matching system 106 obtains information concerning products and/or services, i.e., merchant offerings data, offered by the new merchant (step 404). The merchant offering data for a merchant may include at least one of a good, such as a product, a service provided by the merchant 108, pricing information, geographic location associated with the item, information about the products and/or services, discount offered, experience(s) associated with the item, a description associated with the products and/or services and the like. The merchant offering data is stored in the merchant offering database 218.

The account holder matching system 106 may obtain the merchant offering data in a plurality of ways. In one embodiment, the merchant offering data may be obtained using a web crawler. The URL address of the new merchant is fed to the web crawler or identified by the system 106 and a web crawl is automatically initiated. The web crawler browses through the merchant's 108 website and gathers information regarding the items. The web crawler may be programmed to visit the merchant's 108 website periodically to track changes in the items offered by the merchant 108. In another embodiment, the merchant offering data may be obtained using the historical transaction data. For example, if a transaction record indicates a merchant offering from the new merchant, information about that merchant is obtained. In yet another embodiment, the new merchant may provide the merchant offering data. The merchant profile may be updated and/or generated based on the data collected during the web crawl. According to an additional embodiment, buyer 102 may enter the merchant offering data in the account holder matching system 106. In yet another embodiment, the merchant offering data may be obtained from a third party service provider. Any other techniques known in the art may also be used to obtain the merchant offering data.

The account holder matching system 106 then analyzes the merchant offering data to define the taxonomy classes (step 406). The taxonomy classes may be created based on the types of products and/or services offered by the merchant 108. For example, if a merchant sells consumer goods, the taxonomy classes may have entries such as personal care products, homecare products, food, beverages, drugs, stationary, hardware and the like. Similarly, if the merchant 108 deals with personal computers, the taxonomy may include classes, such as laptops, desktops, net books, computer peripherals, computer accessories and the like. The example described herein includes a single level taxonomy, though a person skilled in the art will appreciate that any combinations of a single level and multi-level taxonomies can be used without deviating from the spirit and scope of the present disclosure. Also, multiple taxonomies may also be defined for a given merchant depending upon the offered items.

Thereafter, the account holder matching system 106 categorizes the merchant offering data according to the taxonomy classes, thereby creating the profile of the merchant 108 (step 408). In an embodiment, the profile may be displayed to the merchant 108 on an administrator window accessible by the merchant 108. The merchant 108 can then confirm the profile or make suitable modifications. The profile is then stored in the merchant database 216.

The merchant profile may be revised to capture any changes in the products/service offerings of the merchant 108. In this case, steps 404 to 408 are performed. In one embodiment, the merchant profile may be revised periodically after a suitable duration. In other embodiments, the profile may be updated in an asynchronous manner, for example, when a transaction involving a new item offered by the merchant 108 is completed and recorded in the account holder matching system 106.

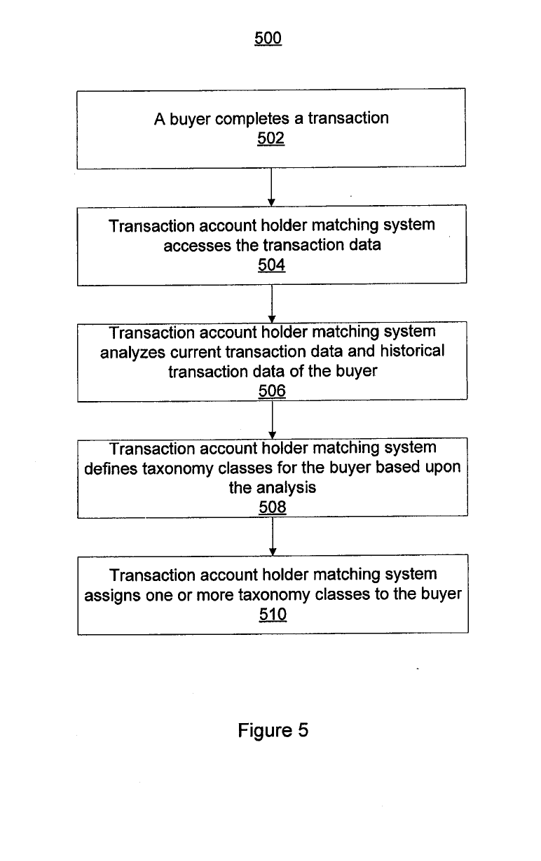

With reference to FIG. 5, the account holder matching system 106 builds profiles for the buyer 102. The profiles are stored in the buyer database 214. The buyer 102 completes a transaction using his/her transaction instrument (step 502). The transaction may either be performed online or may be carried out at a merchant's point of sale.

The account holder matching system 106 accesses data about the transaction (step 504). The transaction data may include name of the buyer, name of the merchant 108, the type of purchased product and/or service, a location of purchase, date of purchase, quantity of purchase, amount spent, description of the merchant 108 and the like. The transaction data may be stored in the transaction history database 212.

Thereafter, the account holder matching system 106 analyzes the current transaction data and the historical transaction data of the buyer 102 (step 506). In various embodiments, the account holder matching system 106 may extract information such as types of goods/services purchased by the buyer 102, frequency of the purchases etc. from the analysis. The account holder matching system 106 then defines taxonomy classes for the buyer 102 based upon the analysis (step 508). Thereafter, the account holder matching system 106 assigns a taxonomy classes to the buyer 102 (step 510) thereby creating a profile for the buyer 102. The profile captures transaction history of the buyer 102 and is representative of the buyer's 102 purchase behavior and interests. For example, if the buyer 102 is a heavy purchaser of consumer electronics and sports accessories, taxonomy classes “sports good” and “consumer electronics” may be assigned to the buyer 102.

The buyer profile may be revised to capture any changes in the products/service purchase behavior of the buyer. In one embodiment, the buyer profile may be revised periodically after a suitable duration. In other embodiments, the buyer profile may be updated in an asynchronous manner, for example, when a transaction involving the buyer 102 is completed and recorded in the account holder matching system 106.

While the steps outlined above represent a specific embodiment, practitioners will appreciate that there are any number of computing algorithms and user interfaces that may be applied to create similar results. The steps are presented for the sake of explanation only and are not intended to limit the scope of the disclosure in any way.

The disclosure has been described herein in terms of functional block components, screen shots, optional selections and various processing steps. It should be appreciated that such functional blocks may be realized by any number of hardware and/or software components configured to perform the specified functions. For example, the account holder matching system 106 may employ various integrated circuit components, e.g., memory elements, processing elements, logic elements, look-up tables, and/or the like, which may carry out a variety of functions under the control of a microprocessor or other control device. Similarly, the software elements of the account holder matching system 106 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the account holder matching system 106 may employ any number of conventional techniques for data transmission, signaling, data processing, network control, and/or the like. Still further, the account holder matching system 106 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a non transitory computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, cloud computing, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the disclosure. It should be understood that the detailed description and specific examples, indicating exemplary embodiments, are given for purposes of illustration only and not as limitations. Many changes and modifications within the scope of the instant disclosure may be made without departing from the spirit thereof, and the disclosure includes all such modifications. Corresponding structures, materials, acts, and equivalents of all elements in the claims below are intended to include any structure, material, or acts for performing the functions in combination with other claim elements as specifically claimed. The scope of the disclosure should be determined by the appended claims and their legal equivalents, rather than by the examples given above. Reference to an element in the singular is not intended to mean “one and only one” unless explicitly so stated, but rather “one or more.” Moreover, where a phrase similar to at least one of A, B, and. C is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

We claim:

1. A method comprising:
establishing, by a computer-based system for matching providers with sales contacts, custom proposed merchant offerings from merchant offerings data, wherein the custom proposed merchant offerings are based at least in part on at least one of a first entity profile and first entity historical transaction account data, and wherein a database is populated with the merchant offerings data;
organizing, by the computer-based system, the custom proposed merchant offerings into a subset of proposed merchant offerings based at least in part on historical transactions account data associated with the first entity;
further organizing, by the computer-based system, the subset of proposed merchant offerings based at least in part on geographic location to create an organized subset of proposed merchant offerings; and
providing, by the computer-based system and through an interface coupled to the computer-based system and to the first entity, the organized subset of proposed merchant offerings.

2. The method of claim 1, wherein the merchant offerings data is populated to the database by at least one of:
receiving transaction account transaction data associated with a transaction account of the first entity,
receiving the merchant offerings data from a participating merchant,
receiving the merchant offerings data from the first entity,
receiving the merchant offerings data from a third party, and
collecting the merchant offerings data from a participating merchant by scraping an internet website of the participating merchant for the merchant offerings data using a website crawler.

3. The method of claim 1, wherein the merchant offerings data comprises at least one of a good, a service, information, experience, an intention of use associated with a product or service, a geographic location associated with a product or service, date, time, weather conditions, seasonal factor, price, and a description associated with a product.

4. The method of claim 1, wherein the organized subset of proposed merchant offerings are presented in rank order.

5. The method of claim 1, wherein the historical transaction account data is associated with at least one of purchases of the first entity and sales of the first entity.

6. The method of claim 1, further comprising providing, by the computer-based system, a statement of historical transaction account data, wherein the statement of historical transaction account data is organized by merchant.

7. The method of claim 6, wherein the statement of historical transaction account data is further organized by a selectable range of time.

8. The method of claim 1, wherein the geographic location further comprises at least one of:
the geographic location of the first entity associated with the merchant offering,
the geographic location of the merchant associated with the merchant offering, and
the geographic location of the merchant offering.

9. The method of claim 1, further comprising searching, by the computer-based system, the database for a targeted merchant offering, in response to receiving the targeted merchant offering request from the first entity.

10. The method of claim 1, further comprising:
matching, by the computer-based system, at least a portion of the historical transaction account data of the first entity with a historical transaction account data of a second entity; and
further organizing, by the computer-based system, the organized subset of proposed merchant offerings based at least in part on historical merchant offerings selected by the second entity.

11. The method of claim 1, further comprising receiving a selection of a distinct merchant offering from the organized subset of proposed merchant offerings.

12. The method of claim 11, further comprising at least one of storing the distinct merchant offering selection and contacting the merchant associated with the distinct merchant offering selection.

13. The method of claim 12, further comprising providing the merchant associated with the distinct merchant offering selection, contact information of the first entity, in response to the first entity selecting the distinct merchant offering for storing.

14. The method of claim 12, wherein the contacting the merchant associated with the distinct merchant offering further comprises initiating a transaction request associated with the distinct merchant offering.

15. The method of claim 11, further comprising:
tracking, by the computer-based system, the selections of distinct merchant offerings; and
organizing, by the computer-based system, the organized subset of proposed merchant offerings based at least in part on historical selections of distinct merchant offerings.

16. The method of claim 1, further comprising:
matching, by the computer-based system, at least a portion of the profile of the first entity with a profile of a second entity; and
further organizing, by the computer-based system, organized subset of proposed merchant offerings based at least in part on historical merchant offerings selected by the second entity.

17. The method of claim 1, further comprising creating, by the computer-based system, at least one of a profile of the first entity and a profile of the merchant.

18. The method of claim 1, further comprising associating, by the computer-based system, the first entity with a first taxonomy class based on at least one of a comparison of the first entity profile and the taxonomy class profile and a comparison of the first entity historical transaction account data and aggregated taxonomy class historical transaction account data.

19. A system comprising:
a tangible, non-transitory memory communicating with a processor for matching providers with sales contacts,
the tangible, non-transitory memory having instructions stored thereon that, in response to execution by the processor, cause the processor to perform operations comprising:
establishing, by the processor, custom proposed merchant offerings from merchant offerings data, wherein the custom proposed merchant offerings are based at least in part on at least one of a first entity profile and first entity historical transaction account data, and wherein a database is populated with the merchant offerings data;
organizing, by the processor, the custom proposed merchant offerings into a subset of proposed merchant offerings based at least in part on historical transactions account data associated with the first entity;
further organizing, by the processor, the subset of proposed merchant offerings based at least in part on geographic location to create an organized subset of proposed merchant offerings; and
providing, by the processor and through an interface coupled to the computer-based system and to the first entity, the organized subset of proposed merchant offerings.

20. An article of manufacture including a non-transitory, tangible computer readable medium having instructions stored thereon that, in response to execution by a computer-based system for matching providers with sales contacts, cause the computer-based system to perform operations comprising:
establishing, by the computer-based system, custom proposed merchant offerings from merchant offerings data, wherein the custom proposed merchant offerings are based at least in part on at least one of a first entity profile and first entity historical transaction account data, and wherein a database is populated with the merchant offerings data;
organizing, by the computer-based system, the custom proposed merchant offerings into a subset of proposed merchant offerings based at least in part on historical transactions account data associated with the first entity;
further organizing, by the computer-based system, the subset of proposed merchant offerings based at least in part on geographic location to create an organized subset of proposed merchant offerings; and
providing, by the computer-based system and through an interface coupled to the computer-based system and to the first entity, the organized subset of proposed merchant offerings.
